(19) United States
(12) Patent Application Publication
(10) Pub. No.: US 2017/0144913 A1
(43) Pub. Date: May 25, 2017

(54) GASEOUS FLUID INJECTION DEVICE

(71) Applicant: AGC GLASS EUROPE, Louvain-La-Neuve (BE)

(72) Inventors: Benoit CHERDON, Roux (BE); Olivier FONTAINE DE GHELIN, Ittre (BE); Laurent DELMOTTE, Meeffe (BE)

(73) Assignee: AGC GLASS EUROPE, Louvain-La-Neuve (BE)

(21) Appl. No.: 15/319,394

(22) PCT Filed: Jun. 1, 2015
(86) PCT No.: PCT/EP2015/062159

§ 371 Date: Dec. 16, 2016

(30) Foreign Application Priority Data
Jun. 17, 2014 (EP) 14172726.3

(51) Int. Cl. C03B 5/193

(52) U.S. Cl. CPC C03B 5/193

(57) ABSTRACT

A device for injecting gaseous fluid into molten vitreous materials in glass furnaces, or for injecting gaseous fluid which is at risk of condensing within the injection device. The device includes a set of concentric walls, including one external wall which is in contact with the molten glass, and one internal wall which is formed by a tube which is axially arranged and guides the gaseous fluid to the end of the device which is dipped into the molten vitreous material, and a cooling circuit based on the flow of a cooling fluid within the device. The internal wall of the tube for injecting the gaseous fluid does not form a wall which is in contact with the cooling fluid flowing within the device.

The present invention relates to a device for injecting gaseous fluids into molten glassy materials in glass furnaces and in particular intended for injecting gaseous fluid that runs the risk of condensing within the injection device.

Specifically, in the procedure for manufacturing glassy materials (float glass, bottle glass, glass fiber, glass wool, etc.) the injection of a gaseous fluid is very often used for in particular ensuring a sufficient mixing of the molten material (molten glass) within the furnace (U.S. Pat. No. 3,397,973, U.S. Pat. No. 3,853,524, EP 2 228 348 for example), injecting materials in gaseous form into the molten glass, controlling certain chemical equilibria or reactions by addition of certain gaseous fluids to the molten glass.

When the gaseous fluid penetrates into the molten glass, several phenomena may occur. The most definite one is the formation of bubbles within the molten glass, it being possible for the size of the bubbles to vary and evolve in the course of their journey within the molten glass. For example, a portion of these bubbles may escape from the molten glass on reaching the surface, another portion may dissolve completely in the molten glass or remain partially or else totally. Gases dissolved in the molten glass may also interact with the bubbles initially formed and thus modify their initial volumes and chemical compositions.

The importance of these various phenomena depends on numerous parameters, in particular the characteristics of the structure of the device, the parameters for injecting the gaseous fluid (constant or pulsed flow rate, flow rates of several Nm³/h are not uncommon, injection pressure, injection temperature), the temperature of the molten glass and its viscosity, density, chemical composition, etc. characteristics.

The structure that is come across most often for the device is often in the form of a tubular assembly through which the gaseous fluid is injected into the molten glass. This tubular assembly passes through one of the walls of the furnace in order to come into contact with the molten glass. An arrangement very often encountered is a vertical position in the bottom of the furnace (referred to as the hearth of the furnace). In this case, one of the ends of the device is below the hearth of the furnace and the other, referred to as the head, opens into the molten glass. This head is either level with the hearth or more deeply inserted into the mass of molten glass. It is common to sink the device several tens of centimeters into the molten glass. Non-vertical arrangements are also possible, for example inclined or even horizontal arrangements. Gaseous fluid is supplied from the end located outside of the furnace and the gas is injected into the molten glass through the head.

The portion of the device between the head and the wall of the furnace is in contact with the molten glass. This portion is therefore exposed to high temperatures, between 1000° C. and 1500° C., and to a harsh and corrosive medium which is the molten glass. In such an environment, in order to mechanically and thermally withstand and prevent corrosion and erosion of the device, it is necessary to provide a suitable technical production. This involves a choice of appropriate material and in almost all cases involves a cooling system. The materials commonly used are mechanical steel (ST 37 for example), steel grades (refractory steels), refractory ceramic materials, noble metals such as platinum or its alloys.

Depending on the choice of the material, it is advisable to maintain the device within an appropriate temperature range within the molten glass. This is commonly achieved by controlling its temperature via a cooling of the device. The larger the portion that is in contact with the molten glass, the more effective this cooling should be. For quite common tubular productions made of steel, it is endeavored to remain below 500° C. approximately and preferably in the vicinity of 450° C., in particular in the welding zones.

One very common cooling system is produced by the forced circulation of a coolant within the device. The coolants most commonly used are water, oil, a mixture of oil, silicone oil, a mixture of silicone oil. For each type of circulation and coolant envisaged, operating constraints appear, in particular the maximum temperature that the coolant may reach without adversely affecting its quality and condition, the maximum pressure withstood by the circuit, the flow rate to be provided, etc. For water for example, it is endeavored in general not to exceed around 50° C. and to preferably remain in the vicinity of 40° C. within the device in order to guard against precipitation, deposition and clogging phenomena within the cooling circuit. These precipitates, deposits and cloggings may generate hot spots within the cooling circuit that may lead to a local vaporization of the water. The result of this is that, at this location, the rate of precipitation and the clogging, and ultimately the amount of deposit and the hardness thereof are increased. This phenomenon is self-sustaining and accelerates by itself. Over time it results in a local heating such that the device may be greatly damaged or even destroyed. The water flow rates used will depend on the geometry of the device and on the contact area with the molten glass, on the type of cooling circuit, etc. Water flow rates of the order of several thousands of liters per hour and per device are quite common.

The consequence of the cooling of the device is a drop in the temperature of the gaseous fluid that it is desired to inject into the molten glass. If this temperature drop is too great, phenomena of condensation of the gaseous fluid injected may occur within the injection device and lead to a partial or even complete injection of the fluid in liquid and not gaseous form into the molten glass.

This injection in liquid form should in general be avoided since it leads to a very rapid return of the injected fluid to the gaseous phase when it comes into contact with the molten glass. This results in the creation of a large number of bubbles of uncontrolled sizes which very often are a source of defects in the finished product, in particular in the manufacture of flat (float) glass. Furthermore, this also leads to an instability of the injection procedure that results in pressure and flow rate variations with a potential pressure surge within the equipment.

It is therefore advisable to avoid these phenomena of condensation of the injected gaseous fluid within the injection device. In order to solve this problem, it is advisable to ensure that the temperature of the injected gaseous fluid will not drop below its condensation temperature set by the injection operating conditions (pressure, characteristics of the fluid which may be a pure gas or a mixture of various gases). For example, if the injected gaseous fluid is steam or a gas mixture containing at least 50% steam, the temperature will not drop below about a hundred degrees.

Given the need for control of the temperature of the device within the molten glass, there is therefore a compromise to be found between adequate cooling of the device in order to preserve its mechanical strength and its resistance to corrosion and erosion, and maintaining the temperature of the injected fluid above its condensation temperature.

The present invention relates to an advantageous device that enables the injection of a gaseous fluid into molten glassy materials in glass furnaces while ensuring that the injected fluid remains in the gas phase in the device, despite the presence of a circulation of coolant, ensuring the mechanical strength and the resistance to corrosion and erosion of the device within the molten glassy material.

The device according to the invention as presented in claim 1 differs from the prior art in that it comprises a system for thermally insulating the pipe carrying the injected gaseous fluid relative to the cooling system used within this type of device. This insulating system is composed of a chamber that separates the gaseous fluid injection pipe from the cooling circuit. This hollow chamber is filled with a gas that may or may not circulate, for example air. The geometry of this chamber and its size depends on the degree of insulation desired and on the general structure of the device.

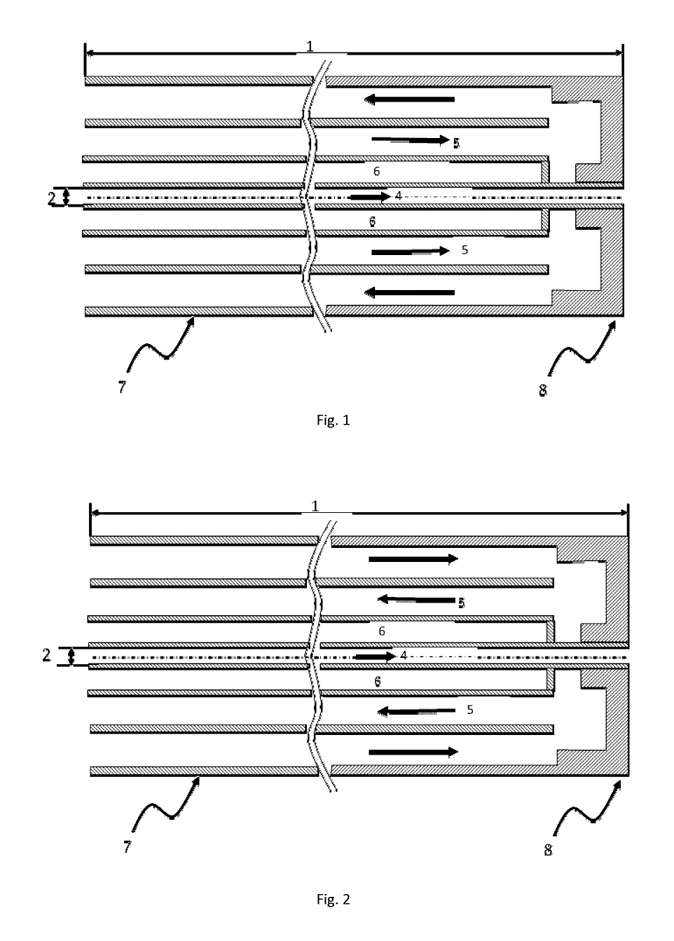

Examples of the production and operation of the device are illustrated hereinafter. In FIGS. 1 and 2, a first production example is given. The device is in general placed vertically and passes right through the bottom of the furnace. The material for producing it is commonly mechanical steel (ST27 for example) but may also be other grades of steel and/or noble metals such as platinum and its alloys. The portion 7 is located outside of the molten glass, below the hearth of the furnace. The portion 8, referred to as the head of the device, is the portion of the device closest to the surface of the molten glass bath. Through the central portion 4, a gaseous fluid is injected into the molten glass. Between the head of the device 8 and the hearth of the furnace, the device is in contact with the molten glass.

Due to this contact between the very hot molten glass (between 1000° C. and 1500° C.) and the material, it is necessary to cool the device. One method that is very often used consists in circulating a coolant 5 within the device. This fluid is for example water. Two circulations are possible. Either, as in FIG. 1, the coolant enters through the center and comes out again by going along the outer wall, or as in FIG. 2, the coolant enters by going along the outer wall and comes out of the device again through the center. In order to thermally insulate the gaseous fluid injection pipe from the cooling circuit, an insulation zone is placed between the cooling circuit and the injection circuit. This zone takes the form of an insulation chamber 6 filled with a gas, for example air. This chamber is present over virtually the entire length 1 of the device. In this first version, this insulation chamber 6 stops before the head of the device 8. The two configurations for circulation of the coolant are not equal from a point of view of the thermal insulation of the central injection tube. The configuration from FIG. 2 gives better results for thermal insulation of the central tube.

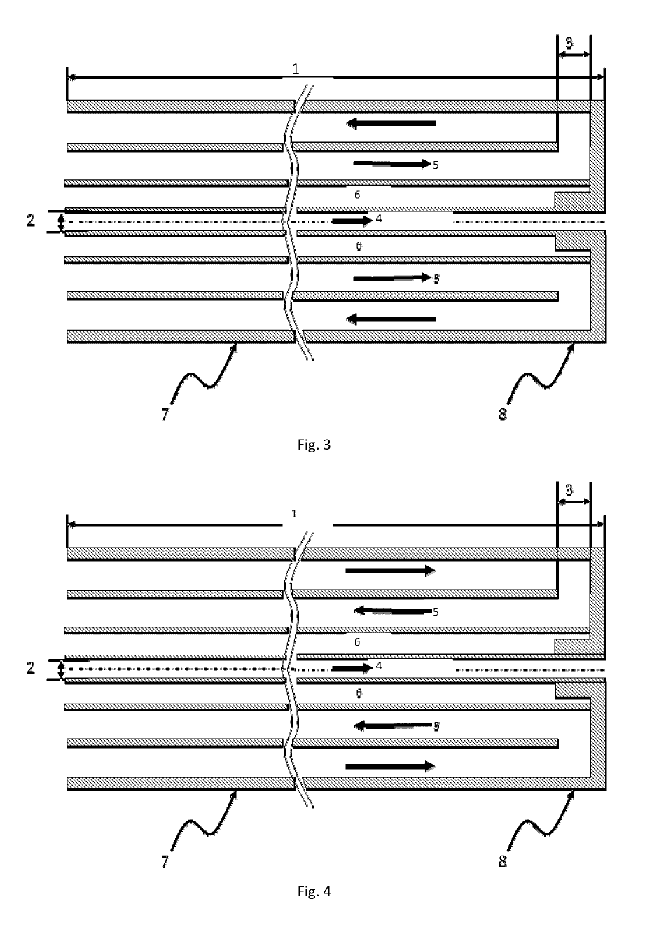

In FIGS. 3 and 4, a second version of the device is presented. The method of operation and the general characteristics are similar to the first version. The difference lies in the shape of the head of the device 8 and of the insulation chamber 6. Specifically, in this case, the insulation chamber 6 continues up to the head of the device 8, which is not the case in the previous version. Here too, the cooling circuit 5 may be created in two different directions. Either from the center towards the outside as in FIG. 3 or from the outside towards the center as in FIG. 4. As in the previous version, these two ways of proceeding are not equivalent from a point of view of the thermal insulation of the central gaseous fluid injection portion 4. The version from FIG. 4 is the most effective. The dimension 3, i.e. the passage distance of the coolant channel at the head of the device 8 is, for this version, of the order of 10 mm.

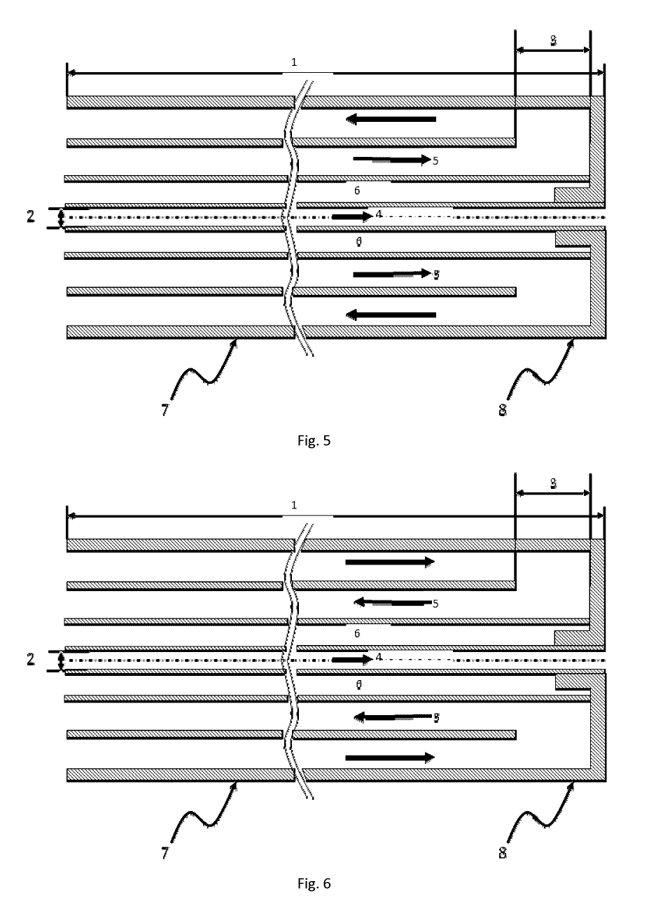

In FIGS. 5 and 6, a third version is presented. It differs from the preceding one in that the distance 3 is greater, between 20 and 30 mm. As for the preceding versions, two directions of circulation of the coolant are possible. As for the first two versions, the version from FIG. 6 is the most effective. This modification of the cooling channel 5 at the head of the device 8 makes it possible to reduce the flow velocity at the head 8. The consequence is a reduction in the efficiency of the cooling at the head 8 but also an improvement in the thermal insulation of the central injection pipe 4 close to the outlet. The optimum for this distance 3 is a compromise between the need to maintain the outer envelope of the device at an acceptable temperature level and the desire to preserve a sufficient temperature of the injected gaseous fluid in order to avoid phenomena of condensation of said gaseous fluid. In the case of a steel fabrication, it is endeavored not to exceed temperatures of the order of 500° C. for the metal portions, in particular in the welding zones. For example, in the case of injecting steam, it is endeavoured to maintain its temperature within the injection device above about a hundred degrees Celsius.

For the three versions presented, the total length of the device 1, i.e. between the two ends 7 and 8, is in general in the vicinity of 1.50 m. The diameter 2 of the central gaseous fluid injection pipe 4 is of the order of 5 to 10 mm. The portion of the device that is in contact with the molten glass, i.e. the portion between the head of the device and the wall of the furnace is of the order of 0 to 0.6 m. The flow rates of gaseous fluid 4 injected into the molten glass are between 0 and 3.5 Nm³/h. In the case of injecting steam, the injection temperature is at least 100° C. The injection pressure is between 1 and 4 to 5 bar.

As mentioned above, cooling of the device is necessary, for steel fabrications in particular. In the case of using water as coolant, it is generally ensured that the temperature of the water does not exceed about fifty degrees Celsius in order to avoid problems of precipitations and deposit of mineral materials and clogging of the cooling circuit. These deposits and cloggings are ultimately a source of poor heat exchanges between the cooling water and the device. Where these deposits and cloggings stagnate, the water may even turn to steam with the consequences of increasing the rate of precipitation and of deposition, of reducing the cooling even more and thus of self-sustaining the phenomenon and accelerating it. This may lead to the destruction of the device: leakage from the cooling circuit, entry of coolant water into the molten glass and generation of defects in the molten glass. In general, these defects may take the form of bubbles, metal inclusions, metal oxide inclusions, etc. It is obvious that these defects should be proscribed since they are unacceptable, in particular for the production of flat glass. This regulation of the temperature of the coolant is carried out by a sufficient coolant flow rate. In the case of using water as coolant, a standard flow rate is between 1000 and 4000 liters/hour and preferably in the vicinity of 2000 liters/hour.

1-11. (canceled)

12. A tubular device for injecting gaseous fluid into a bath of molten glass in a glass melting furnace, comprising:
a set of concentric walls, including an outer wall in contact with the molten glass and an inner wall formed by an axially positioned tube carrying the gaseous fluid to an end of the device immersed in the molten glass,
between the inner and outer walls a coolant circulating in a loop longitudinally along the outer and inner walls in one or other direction, with reversal of a circulation direction in a vicinity of the injection end of the gaseous fluid,
the circulation being realized by an intermediate wall, positioned between the inner and outer walls,
wherein the tube carrying the gaseous fluid does not form a wall in contact with the coolant.

13. The device according to claim 12, wherein the tube carrying the gaseous fluid injected is jacketed with a concentric pipe at a distance from the tube carrying the gaseous fluid injected into the molten glass.

14. The device according to claim 13, wherein a space between the tube carrying the gaseous fluid injected into the molten glass and the pipe concentric to the tube is filled with a gas, limiting heat exchange between the cooling and the gaseous fluid injected into the molten glass.

15. The device according to claim 14, wherein the gas is air which is not made to circulate.

16. The device according to claim 12, wherein the end immersing in the molten glass is closed by welding with exclusion of the tube for injecting the gaseous fluid.

17. The device according to claim 12, wherein the outer wall is made of steel.

18. A process for using the device according to claim 12, wherein circulation of the coolant is regulated so that temperature of the wall in contact with the glass does not exceed a temperature limit to maintain a sufficient mechanical strength and reduce corrosion and erosion phenomena of the material in contact with the molten glass, the temperature limit being of order of 500° C. for steel constructions.

19. The process according to claim 18, wherein the gaseous fluid injected is steam or a gas mixture containing at least 50% steam, the circulation of the coolant being regulated so that the temperature of the tube carrying the gaseous fluid is not lower than the condensation T° of the gas or the mixture thereof over its entire length.

20. The process according to claim 19, wherein the injected steam flow rate is at most equal to 3.5 Nm³/h.

21. The process according to claim 18, wherein the coolant is based on water, temperature of the water at an outlet of the device being not greater than around 50° C.
